(19) United States
(12) Patent Application Publication
(10) Pub. No.: US 2005/0070345 A1
(43) Pub. Date: Mar. 31, 2005

(54) Sound frequency transmission device

(76) Inventor: Kuei-Feng Pan, Taipei (TW)

Correspondence Address: FULBRIGHT & JAWORSKI L.L.P.;M. John Carson, Twenty-Ninth Floor, 865 South Figueroa, Los Angeles, CA, 90017-2571, US

(21) Appl. No.: 10/947,008

(22) Filed: Sep. 21, 2004

(30) Foreign Application Priority Data
Sep. 30, 2003 (TW) 092217519

(51) Int. Cl. H04B 7/15

(52) U.S. Cl. 455/575.1; 455/90.1; 455/550.1; 455/575.2

(57) ABSTRACT

A sound frequency transmission device for performing sound frequency transmission with an electronic device includes a wireless unit and a carrying member. The electronic device transmits sound frequency signals to the wireless unit or receives sound frequency signals from the wireless unit. The wireless unit in use is hung on a user's ear and performs wireless transmission with the electronic device. The wireless unit has a hooking member. The carrying member is carried on the user's body and has a fastening hole. When the wireless unit is not in use, the hooking member of the wire unit can be hooked to the fastening hole of the carrying member, such that the wireless unit is stored.

### FIELD OF THE INVENTION

The present invention relates to sound frequency transmission devices, and more particularly, to a wireless unit that performs wireless signal transmission to an electronic device and is easily placed on and fastened to a carrying member that can be carried on a user's body, such that the wireless unit is convenient to use and secured from loss.

### BACKGROUND OF THE INVENTION

With advancement of the communication technology, mobile phones have been widely used by most of the people. Since answering or making a phone call when driving a car or riding a motorcycle is very dangerous and easily leads to an accident, it is relatively advisable to use a hands-free communication device for answering or making the call if necessary.

As shown in FIG. 7, a conventional head-carrying hands-free communication device “a” is provided with a head-carrying earphone a1 that comprises a head band a11 and an earphone a12 connected to one end of the head band a11. A microphone a2 having an arm a21 is also mounted on the end of the head band a11 having the earphone a12, wherein the arm a21 has a sufficient length to position the microphone a2 close to a user's mouth. The earphone a12 and the microphone a2 are electrically connected to a mobile phone (not shown) via a cable a31 having a plug a3. As a result, the head-carrying hands-free communication device “a” can be carried on the user's head for the use to answer phone calls received by the mobile phone, thereby preventing a traffic accident from occurrence due to manually operating the mobile phone when driving.

However, the above head-carrying hands-free communication device “a” has undesirable disadvantages. For example, the head band a11 has an arc shape and occupied certain space, making the hands-free communication device “a” not convenient to use and store. Further, when the user wears the earphone a1, the head band a11 is usually pressed on and deforms the user's hair. This disadvantage may not be critical for men, but should be particularly undesirable for women who may have various hair styles and are thus inconvenient to use the head-carrying hands-free communication device “a”.

For a motorcycle rider required to wear a safety helmet, he or she cannot further wear the head-carrying hands-free communication device “a” having the head band a11 underneath the safety helmet. Therefore, it is practically not suitable for the motorcycle rider to wear this hands-free communication device “a” when riding a motorcycle. The hands-free communication device “a” should be improved.

In order to solve the problem caused by the above head-carrying hands-free communication device “a”, an ear-hanging hands-free communication device “b” has been proposed in U.S. Pat. No. 5,210,792, as shown in FIG. 8, comprising an ear hanger b1, an earphone b2 mounted on the ear hanger b1, and a microphone b3. The microphone b3 is connected to the ear hanger b1 via a flexible microphone bar b31, such that the flexible microphone bar b31 can be bent to position the microphone b3 close to the user's mouth. The earphone b2 and the microphone b3 are electrically connected to a mobile phone via a cable b41 having a plug b4. The ear-hanging hands-free communication device “b” can be hung on one of the user's ears for answering phone calls, without the concern of deforming the user's hair caused by the head band a11 of the above head-carrying hands-free communication device “a”. The size of the ear-hanging hands-free communication device “b” is also smaller than that of the head-carrying hands-free communication device “a” and is more convenient for storage.

Although the ear-hanging hands-free communication device “b” has a smaller size than the head-carrying hands-free communication device “a”, the microphone b3 is mounted at one end of the microphone bar b31, making the volume of the ear-hanging hands-free communication device “b” not able to be further reduced. Thereby, the ear-hanging hands-free communication device “b” is still inconvenient for the motorcycle rider wearing a safety helmet to use, and its shape may not conform to all kinds of helmets. And the ear-hanging hands-free communication device “b” having an undesirably larger volume is inconvenient to be carried and stored on the user's body, especially for mobile phone users, and thus should still be improved.

In order to solve the problems caused by the above ear-hanging hands-free communication device “b”, an earplug hands-free communication device “c” has been proposed, as shown in FIG. 9, comprising an earplug earphone c1, a microphone c2 connected to the earphone c1 via a cable c3, and a plug c4 mounted at one end of the cable c3. The microphone c2 has a clip c21 that can be fastened on the user's clothes. The earphone c1 can be placed in the user's ear. The plug c4 can be inserted to a mobile phone. Thereby, the user can use the earplug hands-free communication device “c” to answer phone calls.

By the use of the earplug earphone c1 having a small volume and the microphone c2 that can be clipped to the clothes, there is no need to provide a rigid connecting member between the earphone c1 and the microphone c2, thereby not leading to the problem of inconvenient carrying or storage due to the large volumes of the above head-carrying hands-free communication device “a” having the arm a21 and the above ear-hanging hands-free communication device “b” having the microphone bar b31. Further due to the relatively small volume of the earplug hands-free communication device “c”, the communication device “c” carried by the user's ear would not interfere with a safety helmet worn on the user's head, thereby easy to be used and portably carried. Therefore, the earplug hands-free communication device has been widely used and popularized in the market due to its simple structure and low price.

However, all the above hands-free communication devices “a”, “b” and “c” require the use of cables a31, b41, c3 respectively with plugs a3, b4, and c4 to be electrically connected to the mobile phone. The cables a31, b41, c3 may cause inconvenience in use, or cause bad electrical connection due to undue pulling force exerted on the cables a31, b41, c3 thereby adversely affecting the quality of communication. Once the cables a31, b41, c3 are pulled and broken, the hands-free communication devices “a”, “b” and “c” fail.

In order to solve the problems caused by using the cables, it is preferable to adopt wireless transmission to replace the traditional wired transmission. Currently, short-distance wireless transmission such as Bluetooth technology has been developed the earliest and widely used in mobile phones. Commercially available wireless hands-free communication devices or earphones for the mobile phones have structures similar to those described above, which are inconvenient for storage or carrying. Although the problems from the use of cables have been overcome, the size and weight of the hands-free communication devices or earphones still cause inconvenience in use and adversely affect their intended effects.

### SUMMARY OF THE INVENTION

In light of the above drawbacks in the prior art, an objective of the present invention to provide a sound frequency transmission device comprising a wireless unit (such as hands-free earphone) that performs wireless signal transmission with an electronic device (such as mobile phone), wherein the wireless unit can be fastened to a carrying member (such as string or key ring) that is carried on a user's body, such that the wireless unit is convenient to use and prevented from loss.

Another objective of the present invention to provide a sound frequency transmission device, which can perform wireless signal transmission with an electronic device and which is small in size for a user to conveniently wear on the ear.

A further objective of the present invention to provide a sound frequency transmission device that can perform wireless signal transmission with an electronic device, thereby not having the problems caused by the wired signal transmission in the prior art.

In order to achieve the above and other objectives, the present invention provides a sound frequency transmission device comprising a wireless unit and a carrying member, for performing sound frequency transmission with an electronic device. The electronic device can transmit sound frequency signals to the wireless unit and receive sound frequency signals from the wireless unit. The wireless unit includes a microphone and/or an earphone. The wireless unit in use is hung on a user's ear to perform wireless transmission of sound frequency signals with the electronic device, thereby eliminating the disadvantages caused by wired transmission in the prior art. The wireless unit further includes a hooking member, and the carrying member has a fastening hole. The carrying member is carried on the user's body. The hooking member of the wireless unit can be fastened to the fastening hole of the carrying member such that the wireless unit is easily carried and stored and is prevented from loss when the wireless unit is not in use.

Furthermore, the wireless unit may be further provided with an ear hanger that can be securely hung on the user's ear, thereby preventing the wireless unit from dropping.

The electronic device can be a mobile phone, personal digital assistant (PDA), walkman, compact disc player, or flash memory card reader. When the electronic device operates with the wireless unit, the wireless unit can perform two-way sound frequency transmission (having both microphone and earphone) or one-way sound frequency transmission (having microphone or earphone).

The carrying member may be further provided with a string or key ring. The string or key ring can be easily carried on the user's body for portable use.

### BRIEF DESCRIPTION OF THE DRAWINGS

The present invention can be more fully understood by reading the following detailed description of the preferred embodiments, with reference made to the accompanying drawings, wherein:

FIG. 1 is a perspective view of a sound frequency transmission device according to the present invention used in combination with a portable electronic device;

FIG. 2A is a rear view of a wireless unit of the sound frequency transmission device according to the present invention;

FIG. 2B is a side view of the wireless unit of the sound frequency transmission device according to the present invention;

FIG. 3A is a perspective view of a carrying member of the sound frequency transmission device according to a preferred embodiment of the present invention;

FIG. 3B is a perspective view of the carrying member of the sound frequency transmission device according to another embodiment of the present invention;

FIG. 4 is a perspective view of the wireless unit fastened on the carrying member of the sound frequency transmission device according to the present invention;

FIG. 5 is an exploded view of the wireless unit and the carrying member of the sound frequency transmission device;

FIG. 6 is an exploded view of the wireless unit of the sound frequency transmission device and a charging device;

FIG. 7 (PRIOR ART) is a schematic diagram of a conventional head-carrying hands-free communication device;

FIG. 8 (PRIOR ART) is a schematic diagram of a conventional ear-hanging hands-free communication device disclosed in U.S. Pat. No. 5,210,792; and

FIG. 9 (PRIOR ART) is a schematic diagram of an earplug hands-free communication device.

### DETAILED DESCRIPTION OF THE PREFERRED EMBODIMENTS

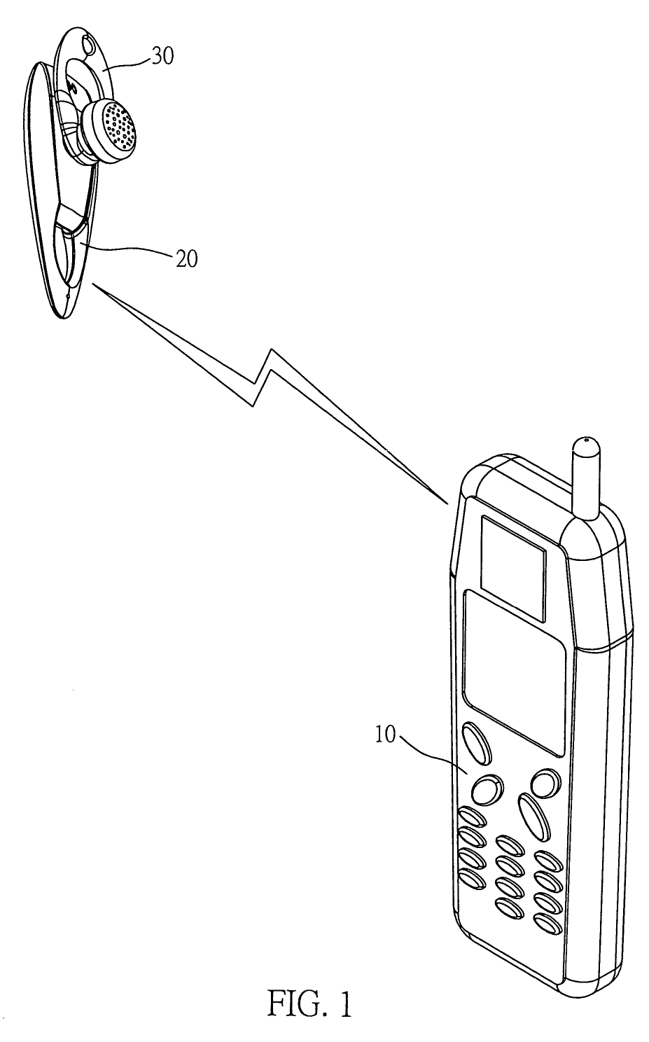

Referring to FIG. 1, a sound frequency transmission device proposed in the present invention includes a wireless unit 20 and a carrying member 30. The sound frequency transmission device performs sound frequency transmission with a portable electronic device 10 that can transmit and receive sound frequency signals.

The portable electronic device 10 is, for example, a mobile phone, personal digital assistant (PDA), or music media player such as walkman, compact disc player or flash memory card reader, etc.

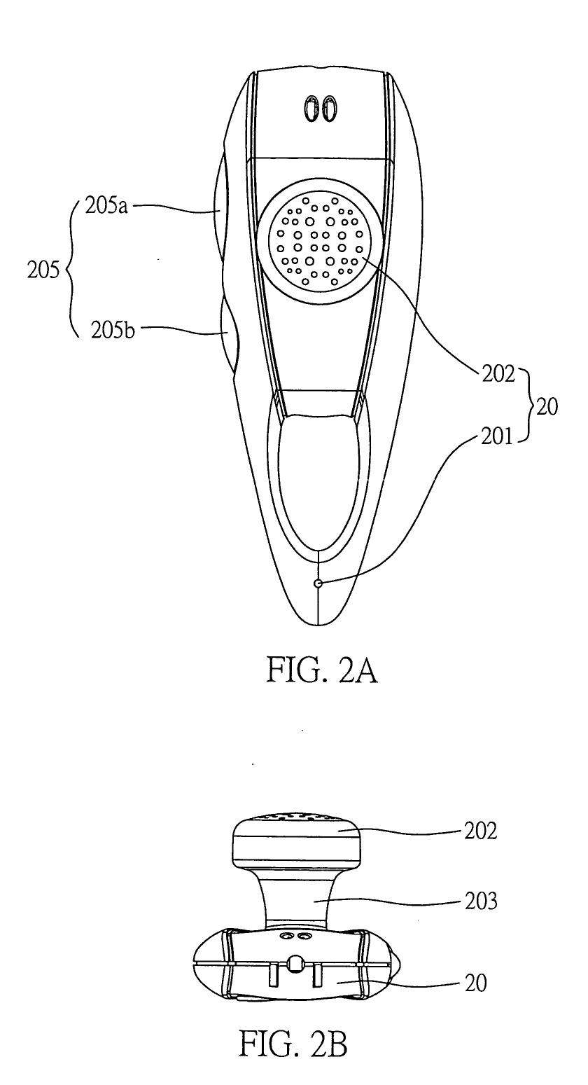

The wireless unit 20 includes a sound frequency processing module such as a microphone 201 and an earphone 202. The microphone 201 of the wireless unit 20 is used to transmit sound frequency signals to the portable electronic device 10, and the earphone 202 is used to receive sound frequency signals from the portable electronic device 10. The microphone 201 and earphone 202 process the sound frequency signals transmitted by the wireless unit 20 so as to allow a user to obtain the processed sound frequency signals. The wireless unit 20 is further provided with a hooking member 203, wherein the earphone 202 is connected to one end of the hooking member 203, as shown in FIGS. 2A and 2B.

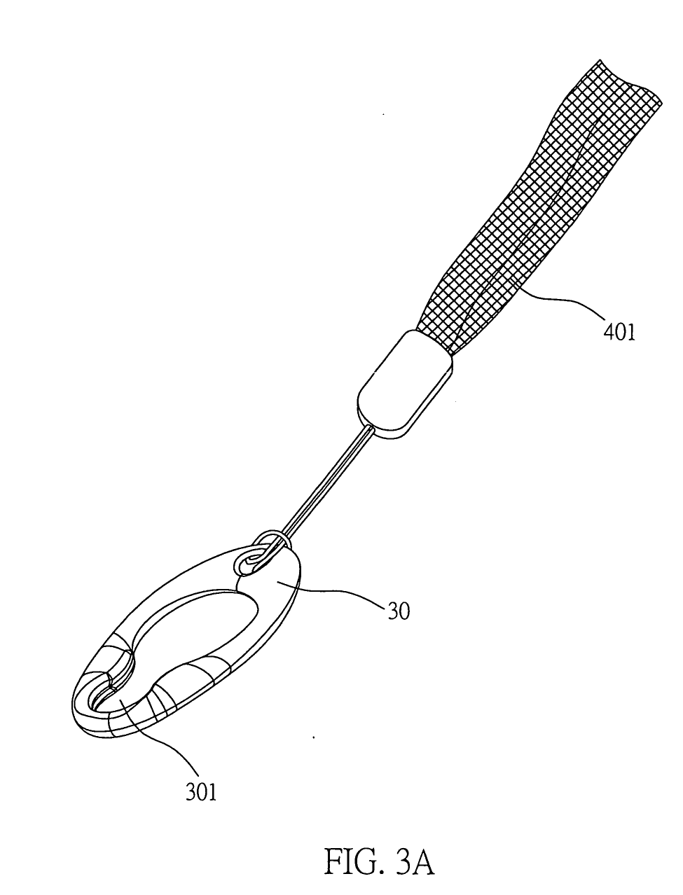

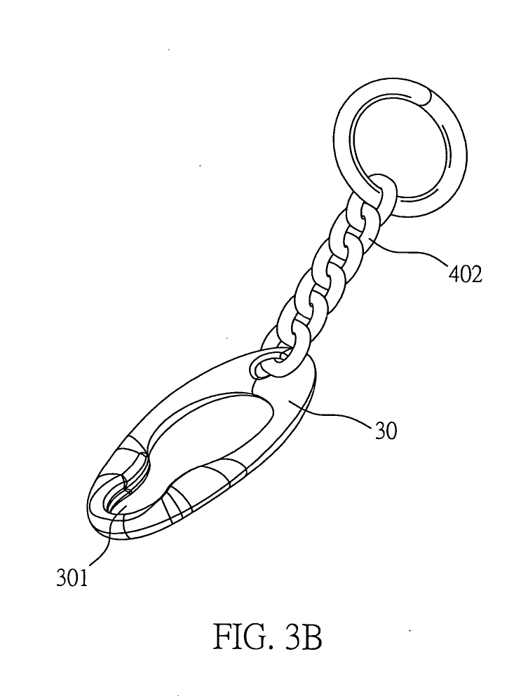

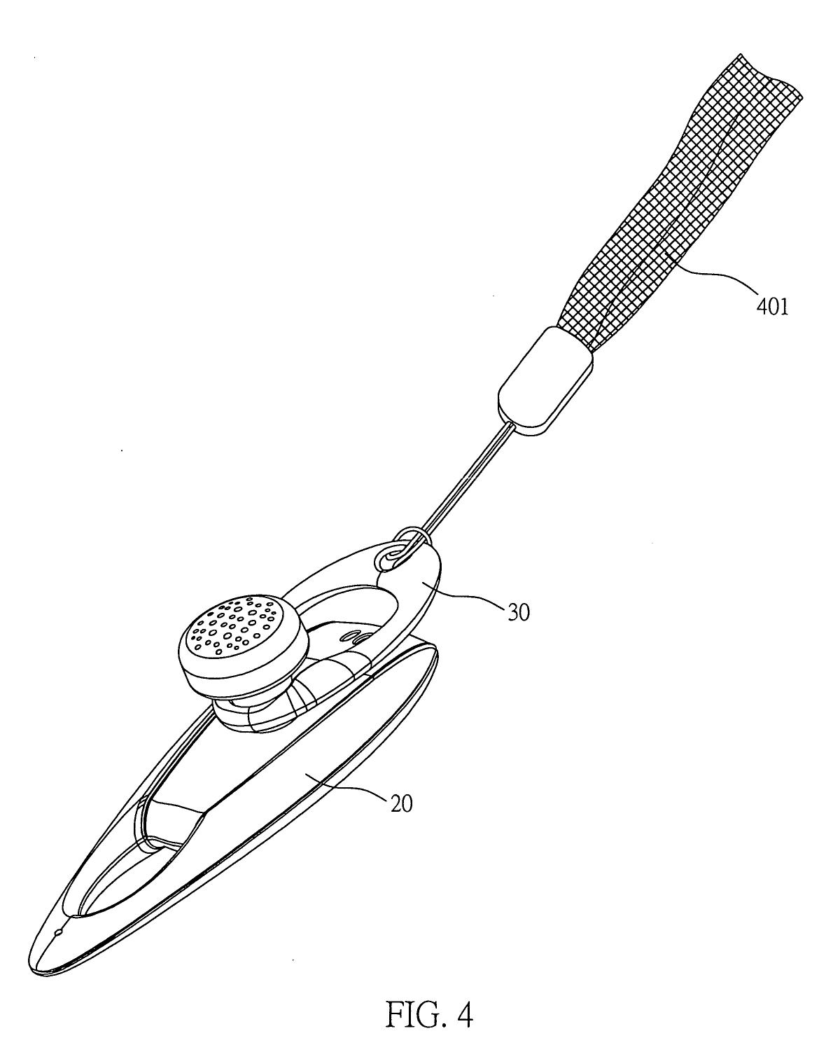

The carrying member 30 is formed with a fastening hole 301 and may be cooperative with a string 401 or key ring 402, as shown in FIGS. 3A and 3B. The carrying member 30 is hung on the user's body via the string 401 or key ring 402, and the hooking member 203 of the wireless unit 20 is fastened to the fastening hole 301 of the carrying member 30, as shown in FIG. 4, such that the wireless unit 20 coupled to the carrying member 30 is portable.

By the above structural arrangement that the carrying member 30 cooperative with the string 401 or key ring 402 can be hung on the user's neck or waist respectively, or carried together with keys on the key ring 402, or carried on a suitcase or bag, the carrying member 30 is thus conveniently brought along with the user.

When the wireless unit 20 is not in use, the hooking member 203 of the wireless unit 20 is inserted in and hooked to the fastening hole 301 of the carrying member 30 so as to couple the wireless unit 20 to the carrying member 30 such that the wireless unit 20 is conveniently stored. On the other hand, when the wireless unit 20 is to be used, the wireless unit 20 is easily removed from the carrying member 30. Since the wireless unit 20 is hooked to the carrying member 30 for storage, the wireless unit 20 is portable and convenient to use without being lost.

Furthermore, the wireless unit 20 is small in size and light in weight, such that the earphone 202 of the wireless unit 20 can be directly placed in the user's ear, making the wireless unit 20 hung on the ear to perform hands-free communication in case operating with the mobile phone or PDA. This arrangement allows the wireless unit 20 to be conveniently carried and used by the user, and overcomes the disadvantages caused by the conventional structure in the prior art.

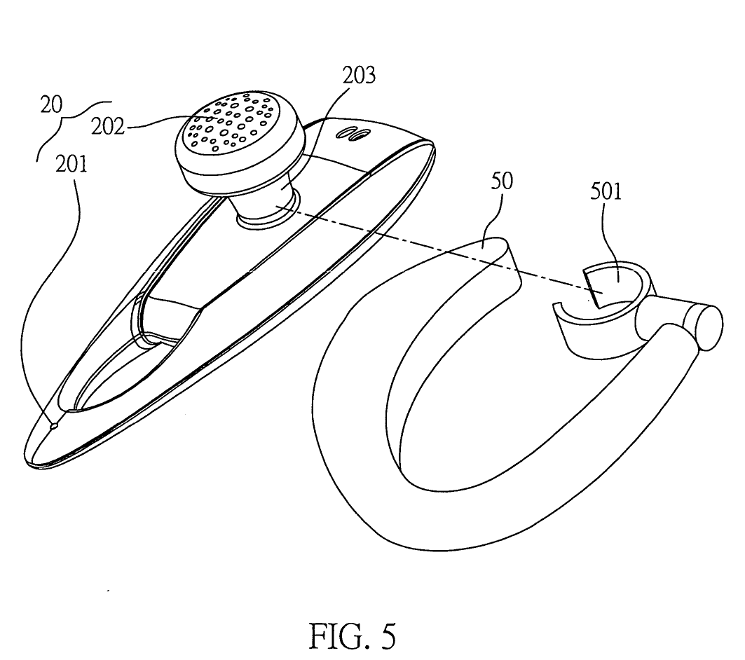

In another preferred embodiment, referring to FIG. 5, the wireless unit 20 may be further provided with an ear hanger 50 having a claw 501. By engaging the hooking member 203 of the wireless unit 20 with the claw 501, the ear hanger 50 enhances the security of wearing the wireless unit 20 on the user's ear, such that the wireless unit 20 can be firmly hung on the user's ear and prevented from falling off.

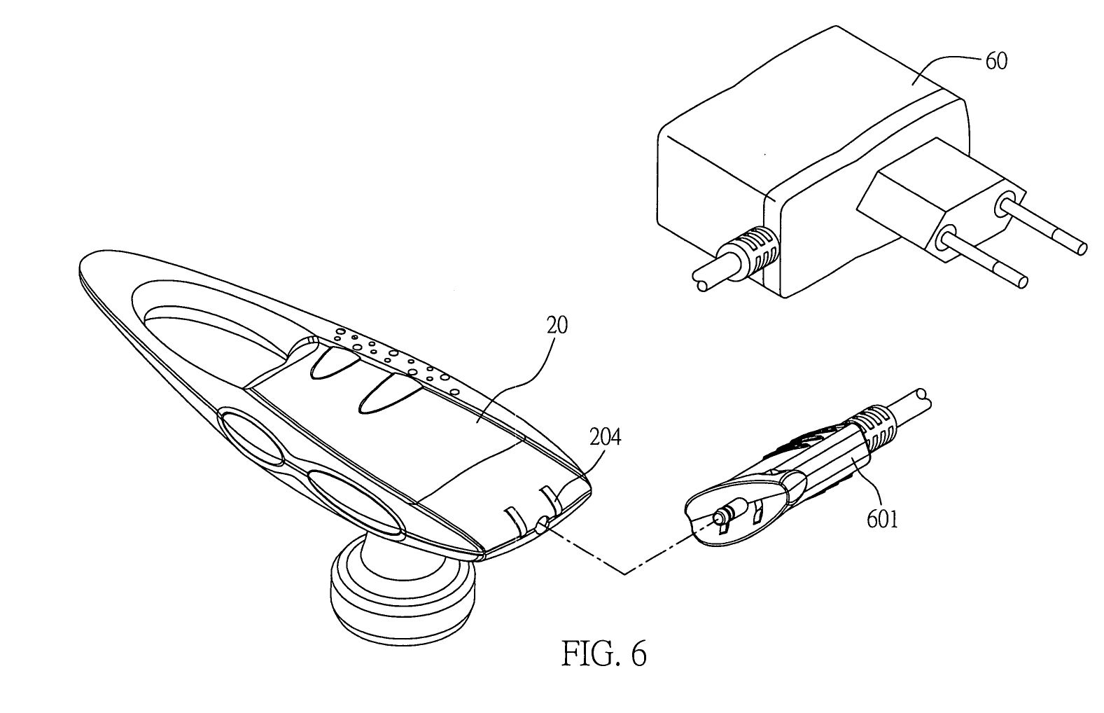

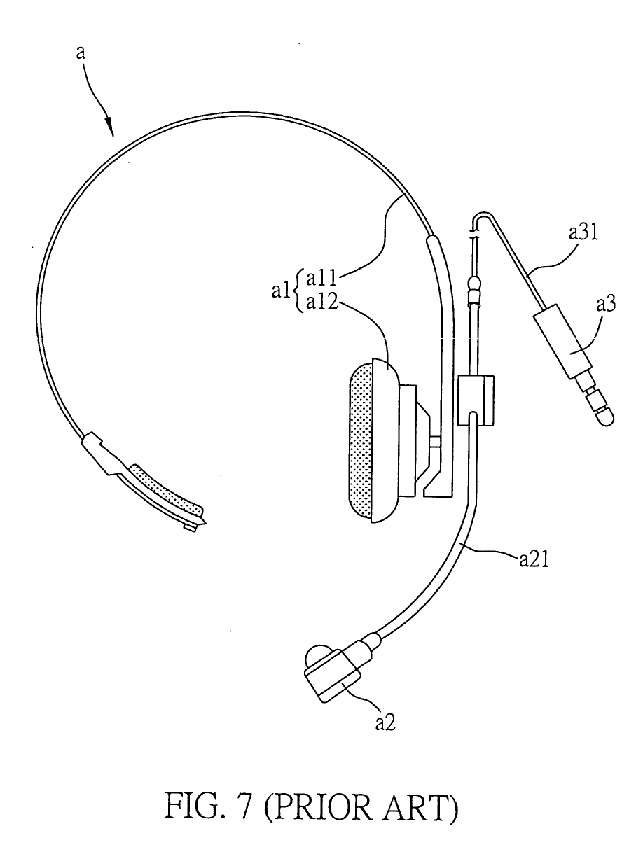

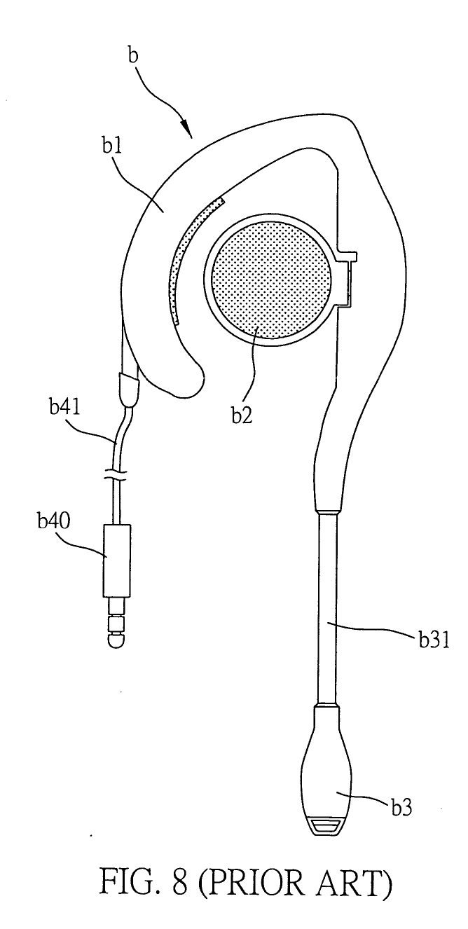

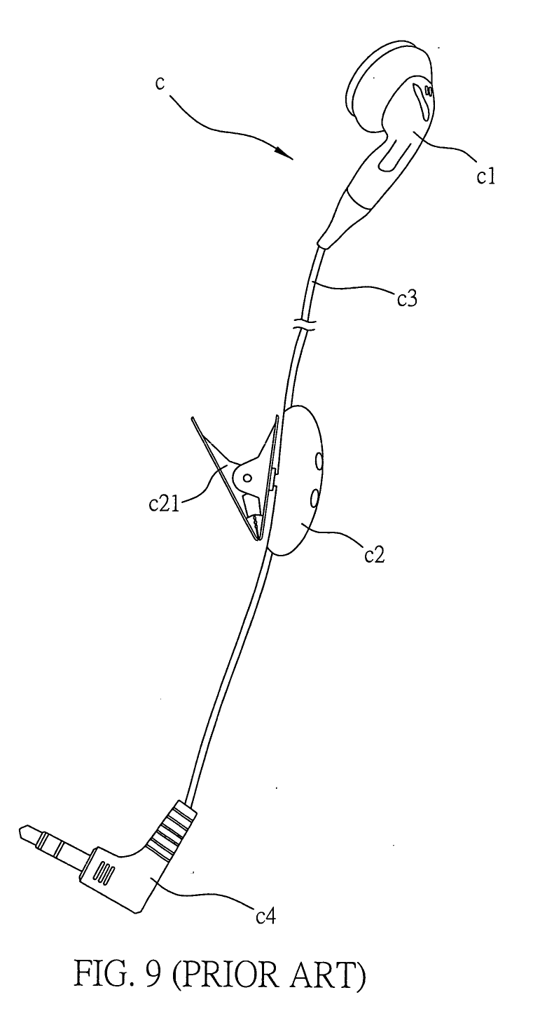

Referring to FIG. 6, the wireless unit 20 further comprises a receptacle 204 for receiving a plug 601 of a charging device 60. A rechargeable battery (not shown) may be mounted in the wireless unit 20 and charged by an external power supply from the charging device 60, which avoids battery replacement and is relatively more environmental friendly.

Moreover, referring to FIG. 2A, the wireless unit 20 further comprises a sound-volume control switch 205. The sound-volume control switch 205 includes two control buttons 205a, 205b to adjust the sound volume of the earphone 202.

In addition to two-way sound frequency transmission via the microphone and earphone of the wireless unit, the wireless unit can be alternatively provided with the microphone or earphone to perform one-way sound frequency transmission via the microphone or earphone.

The invention has been described using exemplary preferred embodiments. However, it is to be understood that the scope of the invention is not limited to the disclosed embodiments. On the contrary, it is intended to cover various modifications and similar arrangements. For example, in addition to having both the microphone and earphone to provide two-way sound frequency transmission in the above embodiments, the sound frequency transmission device may also have one of the microphone and earphone to achieve one-way sound frequency transmission. The scope of the claims, therefore, should be accorded the broadest interpretation so as to encompass all such modifications and similar arrangements.

1. A sound frequency transmission device for performing sound frequency transmission with an electronic device, the sound frequency transmission device comprising:
a wireless unit comprising a sound frequency processing module and a hooking member, the wireless unit for performing transmission of sound frequency signals with the electronic device, wherein the sound frequency processing module processes the sound frequency signals transmitted by the wireless unit so as to allow a user to obtain the processed sound frequency signals; and
a carrying member having a fastening hole and carried on the user's body, wherein the hooking member of the wireless unit is capable of being fastened to the fastening hole of the carrying member such that the wireless unit is convenient to carry.

2. The sound frequency transmission device of claim 1, wherein the wireless unit has a receptacle.

3. The sound frequency transmission device of claim 2, wherein the receptacle of the wireless unit is coupled to a plug of a charging device to electrically charge the wireless unit.

4. The sound frequency transmission device of claim 1, wherein the sound frequency processing module comprises a microphone and/or an earphone.

5. The sound frequency transmission device of claim 4, wherein the wireless unit further comprises a sound-volume control switch.

6. The sound frequency transmission device of claim 5, wherein the sound-volume control switch comprises two control buttons to adjust the sound volume of the earphone.

7. The sound frequency transmission device of claim 1, wherein the hooking member is connected to an earphone.

8. The sound frequency transmission device of claim 1, wherein the wireless unit is cooperative with an ear hanger.

9. The sound frequency transmission device of claim 1, wherein the carrying member is cooperative with a string to be carried on the user's body.

10. The sound frequency transmission device of claim 1, wherein the carrying member is cooperative with a key ring to be carried on the user's body.

11. The sound frequency transmission device of claim 1, wherein the electronic device is a mobile phone.

12. The sound frequency transmission device of claim 1, wherein the electronic device is a personal digital assistant.

13. The sound frequency transmission device of claim 1, wherein the electronic device is a portable music media player.

14. The sound frequency transmission device of claim 13, wherein the portable music media player is a walkman.

15. The sound frequency transmission device of claim 13, wherein the portable music media player is a compact disc player.

16. The sound frequency transmission device of claim 13, wherein the portable music media player is a flash memory card reader.
